(19) United States
(12) Patent Application Publication
(10) Pub. No.: US 2001/0007623 A1
(43) Pub. Date: Jul. 12, 2001

(54) Writing instrument

(76) Inventor: Steven Sugarman, Pontprennau (GB)

Correspondence Address: Thomas D. Paulius, VEDDER, PRICE, KAUFMAN & KAMMHOLZ, 24th Floor, 222 North LaSalle Street, Chicago, IL, 60601, US

(21) Appl. No.: 09/747,744

(22) Filed: Dec. 22, 2000

(30) Foreign Application Priority Data
Jan. 8, 2000 (GB) 0000305.3

(51) Int. Cl. B43K 19/00

(52) U.S. Cl. 401/49; 401/195

(57) ABSTRACT

A writing instrument comprises a plurality of sheets of paper 11 wrapped around a tube 10 which form a cap of the writing instrument. Each sheet paper 11 comprises a band of releasable adhesive extending along an edge thereof which extends circumferentially of the tube 10.

### BACKGROUND OF THE INVENTION

This invention relates to a writing instrument such as a pen or pencil.

On certain occasions it is a problem to find a piece of paper on which notes etc. can be written.

British Patent Application No. 2 207 465 discloses a solution to this problem in the form of a pen having a roll of paper contained therein. In use, a length of paper is drawn from the roll and detached using a serrated cutting edge on the pen.

A disadvantage of this arrangement is that it is expensive to manufacture and difficult to use. Furthermore, the detached lengths of paper are scrappy and easy to lose.

### SUMMARY OF THE INVENTION

I have now devised a writing instrument which alleviates the above-mentioned problems.

In accordance with this invention as seen from a first aspect, there is provided a writing instrument comprising a plurality of sheets of paper wrapped around an elongated portion of the writing instrument and adhered to each other by means of a releasable adhesive.

The sheets of paper are attached to each other by means of the adhesive and thus it is relatively easy to detach sheets of paper as and when they are required. The releasable adhesive also enables the sheets of paper to be adhered to other surfaces once they have been detached from the writing instrument.

In one embodiment, the sheets of paper may be wrapped around an elongated body portion of the writing instrument.

In another embodiment the sheets of paper may be wrapped around a detachable cap of the writing instrument.

In another embodiment, the sheets of paper may be wrapped around a tube for engaging with a body portion of the writing instrument or with a detachable cap thereof.

Preferably the sheets of paper each comprise a band of releasable adhesive extending along an edge thereof.

Preferably, the band of adhesive extends circumferentially of the elongated portion of the writing instrument about which the sheets are wrapped.

Also in accordance with this invention, as seen from a second aspect, there is provided an assembly of sheets of paper wrapped around each other, with adjacent sheets of the assembly being secured to each other by means of a releasable adhesive, the sheets extending around an opening into which the end of an elongated writing instrument can be inserted.

Preferably the sheets of paper are wrapped around a tube, which may be closed at one end.

### BRIEF DESCRIPTION OF THE DRAWINGS

An embodiment of this invention will now be described by way of example only and with reference to the accompanying drawings, in which:

FIG. 1 is a perspective view of an assembly of sheets of paper in accordance with this invention, for attaching to a writing instrument;

FIGS. 2a and 2b are side views showing how the assembly of FIG. 1 is attached to a writing instrument.

### DESCRIPTION OF THE EMBODIMENT SHOWN IN THE DRAWINGS

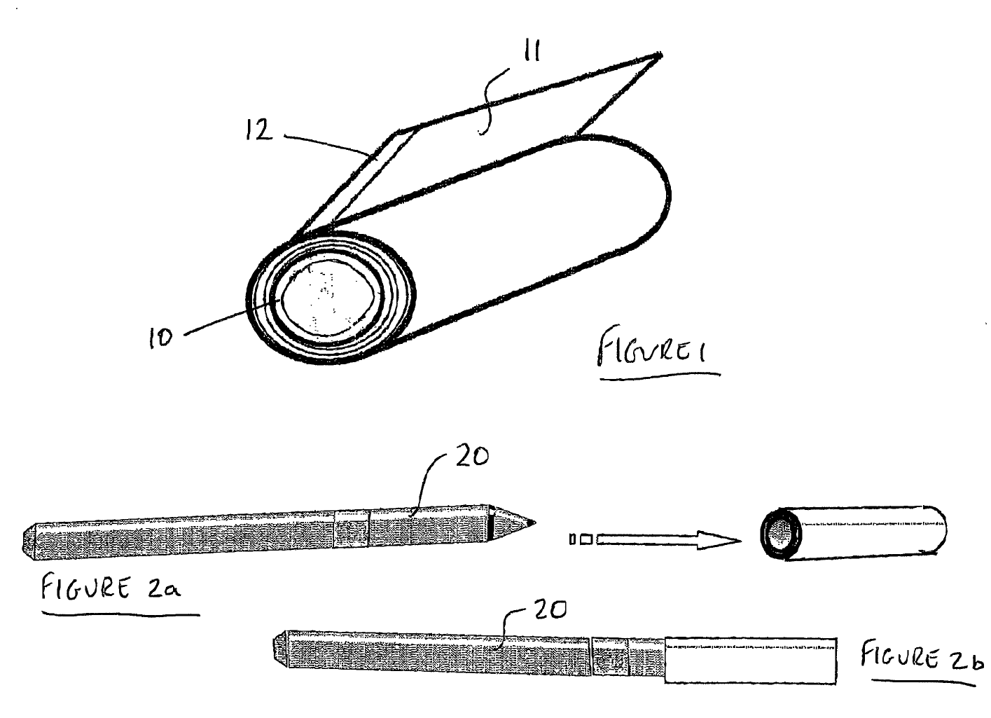

Referring to FIG. 1 of the drawings, there is shown an assembly of sheets of paper comprising an elongated plastic tube 10, which is closed at one end, and a plurality of rectangular sheets of paper 11 wrapped around the tube 10.

The underside of each sheet of paper 11 comprises a strip 12 of a releasable adhesive extending along one edge of the sheet in the direction in which the sheets are wrapped. The strip 12 of releasable adhesive serves to hold the sheets of paper 11 together in a tight formation around the tube 10.

Referring to FIGS. 2a and 2b of the drawings, in use the assembly can be attached to a pen 20 by inserting an end of the pen 20 into the plastic tube 10. The assembly can be fitted to either end of the pen 20, although the tube 10 is advantageously closed at one end, thereby allowing the assembly to function as a cap for the pen.

In use, sheets of paper 11 can be detached by peeling them away from the assembly, so that they can be written on using the pen 20. The sheets of paper 11 can then be adhered to a variety of surfaces for safe-keeping or as reminders.

When the sheets of paper have all been used, a new assembly can be purchased and fitted to the same pen.

I claim:

1. A writing instrument comprising: a plurality of sheets of paper wrapped around an elongated portion of the writing instrument and adhered to each other by means of a releasable adhesive.

2. A writing instrument as claimed in claim 1, in which the sheets of paper are wrapped around an elongated body portion of the writing instrument

3. A writing instrument as claimed in claim 1, in which the sheets of paper are wrapped around a detachable cap of the writing instrument.

4. A writing instrument as claimed in claim 1, in which the sheets of paper are wrapped around a tube engaged with said elongated portion of the writing instrument.

5. A writing instrument as claimed in claim 1, in which the sheets of paper each comprise a band of releasable adhesive extending along an edge thereof.

6. A writing instrument as claimed in claim 1, in which the band of adhesive extends circumferentially of the elongated portion of the writing instrument about which the sheets are wrapped.

7. An assembly of sheets of paper wrapped around each other, with adjacent sheets of the assembly being secured to each other by means of a releasable adhesive, the sheets extending around an opening into which the end of an elongated writing instrument can be inserted.

8. An assembly as claimed in claim 7, in which the sheets of paper are wrapped around a tube.

9. An assembly as claimed in claim 7, in which the tube is closed at one end.
